(19) United States
(12) Patent Application Publication
(10) Pub. No.: US 2010/0128818 A1
(43) Pub. Date: May 27, 2010

(54) FFT PROCESSOR

(76) Inventors: Simon John Shepherd, Bradford Yorkshire (GB); James MacKenzie Noras, Bradford Yorkshire (GB); Yuan Zhou, Bradford Yorkshire (GB)

Correspondence Address: HOFFMAN WARNICK LLC, 75 STATE STREET, 14TH FLOOR, ALBANY, NY, 12207, US

(21) Appl. No.: 12/597,758

(22) PCT Filed: Apr. 25, 2008
(86) PCT No.: PCT/GB08/50301

§ 371 Date: Dec. 16, 2009

(30) Foreign Application Priority Data
Apr. 27, 2007 (GB) 0708181.3

(51) Int. Cl. G06F 17/14; H04L 27/00

(52) U.S. Cl. 375/316; 708/404

(57) ABSTRACT

An N-point FFT processor 100 suitable for large data inputs (e.g. 2 k or 8 k-point input data) is formed from a m-point FFT processor unit 10 and a n-point FFT processor unit 20 in combination, where N=m×n and m and n are any positive integers. First, second and third permutation units 31, 32 & 33 perform global permutations on the data passing through the FFT processor. A twiddle factor unit 40 applies twiddle factors. A digital signal processing apparatus 1100 (FIG. 11) comprising the FFT processor 100 is also described. Further, a testing apparatus 1200 (FIG. 12) is described for testing an N-point FFT processor 100 by selecting amongst a plurality of m-point FFT processor units 10-10c and a plurality of n-point FFT processor units 20a-2c.

### FIELD OF THE INVENTION

The present invention relates in general to the field of fast Fourier transform (FFT) processors.

### BACKGROUND OF THE INVENTION

FFT processors are a vital component of almost all modern digital signal processing systems. In particular, FFT processors are vital in most digital communication systems such as wireless computer networks and cellular telephone systems. For example, digital communication systems based on the OFDM technique use FFTs for signal modulation. 2K, 1K, 512 and 256-point FFT processors are often needed in digital audio broadcasting (DAB) systems, whilst 2K and even 8K-point FFT processors are often required in digital video broadcasting (DVB) systems.

Area, speed and power consumption are three main parameters of an FFT processor, and determine whether a particular FFT processor architecture will be successfully integrated into a digital signal processing (DSP) system. To achieve high throughput and low power consumption, especially in various real-time applications, systolic FFT processors are often used. A systolic FFT processor comprises a chain of processing units (also called pipeline elements or PEs) which pass data through the system continuously. Typically, an N-point systolic FFT processor can complete one transform in N cycles and hence systolic FFT processors are economic in term of clock cycles. However, systolic processors for large FFTs such as 2K and 8K-point FFTs consume large silicon area. Most architectures of the related art include many complex multipliers for multiplications with twiddle factors and commutators for permuting intermediate results, both of which involve a large component area.

Many approaches have been proposed in the related art to reduce silicon area. First, internal shift registers have been used in each pipeline element for scheduling the data entering into a butterfly and storing intermediate results. Second, delay commutators have been used for switching data among data paths. Further, CORDIC techniques, ROM-based designs and parallel adders have each been used to implement multipliers. Finally, radix-8 and radix-16 algorithms instead of radix-2 and radix-4 algorithms have been used to reduce the number of multipliers.

WO-A-2005/052808 describes several different architectures of FFT processors in the related art and in particular discusses a pipelined FFT processor having memory address interleaving between adjacent butterfly units. Here, an interleaver reorders the output of a first butterfly unit so as to provide reordered data in a required order as an input to a subsequent second butterfly unit. However, even this recently published example the related art can be further improved in relation to area, speed and/or power consumption.

### SUMMARY OF THE INVENTION

According to the present invention there is provided an FFT processor as set forth in the claims appended hereto. Also, according to the present invention there is provided a digital signal processing apparatus incorporating such an FFT processor as set forth in the claims appended hereto. Further, according to the present invention there is provided a digital signal processing method as set forth in the claims appended hereto. Further still, according to the present invention there is provided a testing apparatus for testing a FFT processor as set forth in the claims appended hereto. Other, optional, features of the invention will be appreciated from the dependent claims and the discussion that follows.

According to an aspect of the present invention there is provided an FFT processor which, at least in some example embodiments, is economical in terms of the area consumed. The exemplary FFT processor also maintains a high throughput. Further, the exemplary embodiments provide an FFT processor which is readily adapted to different specific implementations and is readily fabricated as a dedicated hardware device. Further still, the exemplary embodiments provide a FFT processor which minimises a number of multipliers and uses a compact and simplified permutation scheme. Thus, the exemplary FFT processor minimises area requirements whilst maintaining a high speed and a high output signal-to-noise ratio (SNR). The exemplary embodiments are particularly beneficial for a large-point FFT processor such as a 2K-point FFT.

In one aspect of the present invention there is provided an N-point FFT processor suitable for large data inputs (e.g. 2 k or 8 k-point input data), comprising an m-point FFT processor unit and an n-point FFT processor unit in combination, where N=m*n and m and n are any positive integers. A first permutation unit is arranged to receive the N words of input data and to permute the input data into first permuted data arranged in n data blocks each of length m words. The m-point FFT processor unit is arranged to perform a fast Fourier transform on the first permuted data to provide first transformed data. A second permutation unit is arranged to permute the first transformed data into second permuted data arranged in m data blocks each of length n words. A twiddle factor multiplication unit comprising a complex multiplier is arranged to multiply each word of the second permuted data by a predetermined twiddle factor to provide twiddle factor multiplied data. The n-point FFT processor unit is arranged to perform a fast Fourier transform on the twiddle factor multiplied data to provide second transformed data arranged in the m data blocks each of length n words. A third permutation unit is arranged to permute the second transformed data into third permuted data and to output the third permuted data as an N-point fast Fourier transform of the input data.

In a further aspect of the present invention there is provided a digital signal processing apparatus, such as a digital audio broadcasting receiver or a digital video broadcasting receiver, comprising a receiver unit arranged to receive input data of length N words, a FFT processor arranged to perform a fast Fourier transform of the N words of input data to produce N words of output data, and an output unit arranged to output the N words of output data, wherein the FFT processor is arranged as set forth herein.

In another aspect of the present invention there is provided a method of performing a fast Fourier transform on N words of input data where N=m×n, where m and n are both positive integers, the method comprising: receiving the N words of input data; permuting the input data into first permuted data arranged in n data blocks each of length m words; performing a fast Fourier transform on the first permuted data using a first m-point FFT processor unit to provide first transformed data arranged in n data blocks each of length m words; permuting the first transformed data into second permuted data arranged in m data blocks each of length n words; multiplying each of the words of the second permuted data by a predetermined twiddle factor to provide twiddle factor multiplied data; performing a fast Fourier transform on the twiddle factor multiplied data using a second n-point FFT processor unit to provide second transformed data arranged in m data blocks each of length n words; permuting the second transformed data into third permuted data; and outputting the third permuted data as an N-point fast Fourier transform of the input data.

In another aspect of the present invention there is provided a computer-readable storage medium having recorded thereon computer instructions to perform any of the methods recited herein.

In a still further aspect of the present invention there is provided a testing apparatus for testing an N-point FFT processor arranged to perform a fast Fourier transform on N words of input data where N=m×n, the testing apparatus comprising a first selector unit arranged to select one of a plurality of m-point FFT processor units, and a second selector unit arranged to select one of a plurality of n-point FFT processor units, whereby the selected one of the plurality of m-point FFT processor units and the selected one of the plurality of n-point FFT processor units are arranged in combination to provide the N-point FFT processor.

### BRIEF DESCRIPTION OF THE DRAWINGS

For a better understanding of the invention and to show how embodiments of the same may be carried into effect, reference will now be made by way of example to the accompanying diagrammatic drawings in which:

FIG. 1 is a schematic block diagram of an FFT processor according to an exemplary embodiment of the present invention;

FIG. 2 is a schematic block diagram of dataflow through the exemplary FFT processor;

FIG. 3 is schematic block diagram of a 2K-point FFT processor according to an exemplary embodiment of the present invention;

FIG. 4 is a schematic block diagram of an exemplary twiddle factor multiplication unit;

FIG. 5 is a schematic block diagram of an exemplary first FFT processor unit;

FIG. 6 is a schematic block diagram of an exemplary second FFT processor unit;

FIG. 7 is a schematic block diagram of an exemplary constant multiplier unit;

FIG. 8 is a schematic block diagram of an exemplary dual-port RAM unit;

FIG. 9 is a schematic floor plan illustrating area consumption of an FFT processor according to an exemplary embodiment of the present invention;

FIG. 10 is a schematic flow diagram illustrating an example FFT processing method;

FIG. 11 is a schematic block diagram of an exemplary digital signal processing apparatus; and

FIG. 12 is a schematic block diagram of an exemplary testing and evaluation apparatus for an FFT processor according to a further aspect of the present invention.

### DETAILED DESCRIPTION OF THE EXEMPLARY EMBODIMENTS

The following detailed description of the exemplary embodiments discusses a 2K-point FFT processor which is suitable for signal demodulation in a digital audio broadcasting (DAB) system. However, it will be appreciated that this example embodiment is not intended to limit the more general teachings of the present invention which will be ascertained by those of ordinary skill in the art from the following detailed description.

The exemplary embodiments of the FFT processor discussed herein balance the competing demands that arise when considering particularly speed (throughput and/or latency), area and power consumption of the processor. Here, throughput concerns the volume of data which the processor is able to handle. Latency concerns the delay between an input signal being received and a useful output being produced from the FFT processor. Area concerns the physical size of the FFT processor, particularly the physical size of the processor when constructed as an integrated circuit as either a stand-alone component or as part of a more complex circuit. Power consumption concerns electric current drawn by the processor in operation, and is particularly relevant in modern hand-held battery-powered equipment.

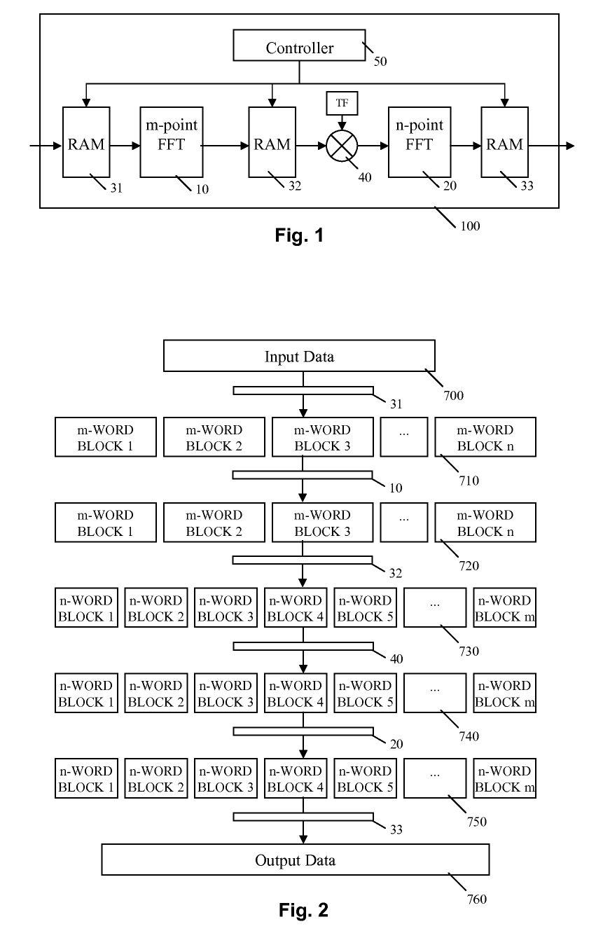

FIG. 1 shows a schematic block overview of the architecture of the exemplary FFT processor 100. Here, the FFT processor 100 comprises first, second and third permutation units 31, 32 & 33, a first FFT processor unit 10, a second FFT processor unit 20, a twiddle factor multiplication unit 40, and a permutation controller 50. Other control elements such as clock signals have not been shown for clarity, because these elements in themselves are familiar to persons of ordinary skill in this art.

The first FFT processor unit 10 and the second FFT processor unit 20 are each self-contained low-point FFT processors. The first and second FFT processor units 10, 20 are used in combination and cooperatively form the high-point FFT processor 100.

The permutation units 31, 32, 33 perform global permutations on the data passing through the FFT processor 100. These global permutations assist in simplifying the twiddle factor multiplication performed by the twiddle factor multiplication unit 40. In particular, the permutation units 31, 32, 33 apply global permutations such that the data lies close to the leading diagonal or effective diagonal of the Fourier matrix. Further, the global permutations allow the FFT processor 100 to receive input data in natural order and to output transformed data in natural order.

In general terms, let the number of points (samples) be N, and let m and n be factors of N such that N=m×n. Here, m and n are both positive integers such that N is any non-prime positive integer. The first FFT processor unit 10 is an m-point FFT processor and the second FFT processor unit 20 is an n-point FFT processor.

The exemplary architecture operates on an N-point data column by dividing into factors m and n and performing, in order, a first permutation, then a Kronecker matrix with m instances of f_trans(n), then a second (inverse) permutation, then a multiplication by a diagonal twiddle matrix, then a second Kronecker with n instances of f_trans(m), and then finally the initial permutation again. Advantageously, data is held (e.g. in local memory) only in sections of size m and n for the two Kronecker phases. Thus, taking the input data as “X” and Pmn′ as the transpose of Pmn, the exemplary architecture can be expressed by the following equation:

F*X=Pmn*kron(ln,Fm)*Dmn*Pmn′*kron(lm,Fn)*Pmn*X

In the special case where N=2n² (i.e. m=2n) then the N-point FFT processor 100 comprises a first 2n-point processor 10 and a second n-point FFT processor 20. Alternatively, in the special case where N=n² (i.e. m=n), then two n-point FFT processors 10, 20 are employed. Thus, it has been found that the architecture of FIG. 1 is most efficient when N is a power of two.

The architecture of FIG. 1 is particularly effective for large-point FFT processors. Here, the exemplary architecture operates efficiently such as where N is greater than 256, more effective still when N is equal to or greater than 1024, and most effective when N is equal to or greater than 2048, because of the increased efficiency of the architecture for larger-point FFTs.

FIG. 2 is a simplified overview of dataflow through the FFT processor 100 of FIG. 1.

The FFT processor 100 receives a set of N-word input data 700 suitably in natural order.

The first permutation unit 31 performs a first global permutation on the N data words to permute the input data 700 into first permuted data 710 which are arranged in n data blocks each of length m words (i.e. n length-m data sequences).

The first FFT processor unit 10 performs a first m-point fast Fourier transform on the first permuted data 710 to provide first transformed data 720. Here, each of the n blocks of length m words is passed separately in turn through the first m-point FFT processor unit 10 and the resultant n blocks are written into the second permutation unit 32 as the first transformed data 720.

The second permutation unit 32 performs a second global permutation on the N data words to permute the first transformed data 720 into second permuted data 730 arranged in m blocks each of length n words (i.e. m length-n data sequences).

The twiddle factor multiplication unit 40 multiplies each of the N words of the second permuted data 730 by a predetermined twiddle factor to provide twiddle factor multiplied data 740.

The second n-point FFT processor unit 20 performs a second fast Fourier transform on the twiddle factor multiplied data 740 to provide second transformed data 750. Here, each of the m blocks of length n words is passed separately in turn through the second n-point FFT processor unit 20 and the resultant m blocks are written into the third permutation unit 33 as the second transformed data 750.

The third permutation unit 33 performs a third global permutation on the N data words to permute the second transformed data 750 into third permuted data 760. The third permuted data 760 is then output as output data from the FFT processor 100 as the N-point fast Fourier transform of the input data 700. Suitably, the third global permutation performed by the third permutation unit 33 provides the output data 760 in the natural order corresponding to the input data 700.

It will be appreciated that the architecture of FIGS. 1 and 2 is readily adapted to perform discrete Fourier transforms (DFT) or inverse fast Fourier transforms (IFFT).

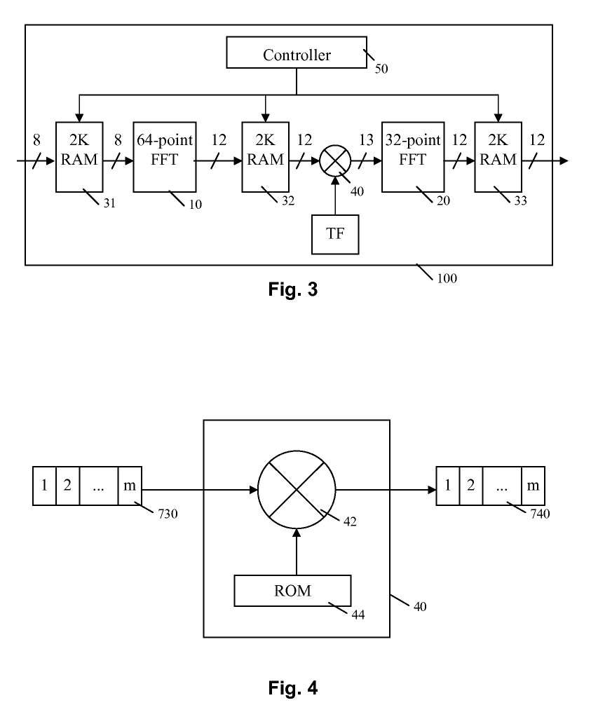

FIG. 3 is a schematic block diagram showing the exemplary FFT processor 100 in greater detail. In this specific example, the 2048-point FFT processor 100 is obtained by combining a first 64-point FFT processor 10 and a second 32-point FFT processor 20. That is, N=2048, m=64 and n=32.

As shown in FIG. 3, the first, second and third permutation units 31, 32 & 33 each comprise a RAM of size N words. In the exemplary embodiments, the permutation units 31, 32 & 33 each comprise a single-port RAM. Conveniently, single-port RAM is more area-efficient, smaller and cheaper than dual-port RAM. Each single-port RAM operates in read-before-write mode whereby data is written into and read from the RAM according to an address signal supplied by the permutation controller 50. The input data is written into the RAM in sequential address order and then read from the RAM according to the permuted address sequence supplied by the permutation controller 50. In this example, the address signal provided by the controller 50 to each RAM 31, 32, 33 repeats every 11*2K clock cycles. Hence, the permutation controller may be constructed with a small number of commonly available components including counters, shifters, modular arithmetic units (e.g. adders) and multiplexers as will be familiar to persons skilled in the art.

The exemplary FFT processor shown in FIG. 3 uses fixed point arithmetic to achieve high speed. A mixed scaling scheme is employed to avoid overflow, which maintains good accuracy whilst keeping the structure of each of the smaller FFT processor units 10, 20 relatively simple. Here, the input word length is 8 bits. The data word length increases to 15 bits after the 64-point first FFT processor unit 10, because the maximum word length increment of a 2^{x}-point FFT is x+1 bits. Then, the data is shifted and chopped to 12 bits at the output of the 64-point first FFT processor 10. Each block of 64 words has one scaling factor and 32 scaling factors are obtained for each 2K of input data. After the second global permutation, each of the 2K data words are adjusted with one scaling factor. The word length is expanded from 13 bits to 19 bits in the 32-point second FFT processor unit 20 and is shifted and chopped to 12 bits at the output thereof. Then, each block of 32 data words has one scaling factor and sixty-four scaling factors are obtained for each 2K of data. After the third global permutation, each 2K of data are adjusted with one scaling factor. Given an input signal-to-noise (SNR) ratio of 48 dB for the 8-bit data, the output SNR is greater than 42 dB with such a scaling scheme. Thus, the exemplary architecture achieves a high output SNR with a simple structure, especially because the permutation RAMs 31, 32, 33 are also used for adjusting word length instead of using extra RAMs at each stage.

In the general case where N=m×n, then the first and third permutations are found from Equation 1 below, while the second permutation is found from Equation 2 below:

1^{st} and 3^{rd} permutations for m*n

for iloop=1, 2, . . . , m, and

jloop=1, 2, . . . , n

ADDR(jloop+(iloop−1)*n)=iloop+(jloop−1)*m Equation 1

2^{nd} permutation for m*n

for iloop=1, 2, . . . , m

and jloop=1, 2, . . . , n

ADDR(iloop+(jloop−1)*m)=jloop+(iloop−1)*n Equation 2

In the special case where N=n² (i.e. where m=n), then conveniently all three permutation units 31, 32, 33 perform the same permutation as expressed by Equation 3 below:

1^{st}, 2^{nd} and 3^{rd} Permutations for m=n

For a=0, log 2(N),

ADDR=b*2̂a mod(N−1), when bε[0 N−2],

ADDR=N−1 when b=N−1,

where b=0, 1, 2, 3, . . . , N−1 Equation 3

Note that the value of “b” repeats every N cycles. Also, the value of “a” changes every N cycles and repeats every 2N cycles.

In the special case where N=n*m (i.e. where m=2n), then the permutation of the second permutation unit 32 is still found in Equation 3 above, whereas the permutations performed by the first and third permutation units 31, 33 are now both expressed by Equation 4 below:

1st and 3^{rd} permutations for m=2n

For a=c*log 2(n)mod log 2(N),

c=0, 1, 2, 3, . . . , log 2(N)−1,

ADDR=b*2̂a mod(N−1), when bε[0 N−2],

ADDR=N−1 when b=N−1,

where b=0, 1, 2 . . . N−1, Equation 4

Here, the value of “a” changes every N cycles and repeats every log 2(N) cycles

For the exemplary embodiment under consideration where N=2048, the input data 700 comprises 2048 eight-bit words which are arranged in an ordered numerical input address sequence, e.g. in a linear sequence from address “1” through to address “2048”. The input data 700 is written into the RAM 31 in this natural order and then read out as the first permuted data 710. The permuted address sequence from the controller 50 selects elements of the input data 700 in turn to form a first block of length m words. Where m=64 and n=32 (i.e. m=2n) as shown in FIG. 3, the first data element and then every subsequent 32^{nd} element of the input data 700 is selected in turn to form a first block of length 64 words. Then, the second block is formed by selecting the second element and every subsequent 32^{nd} element. This process continues iteratively until the 32^{nd} block is obtained by selecting the 32^{nd} element and each subsequent 32^{nd} element including the last 2048^{th} element.

As can be seen by the generic equations expressed above, the second global permutation performed by the second permutation unit 32 rearranges the n blocks each of length m words into m blocks each of length n words.

Finally, the third global permutation performed by the third permutation unit 33 rearranges the m blocks of length n words back into natural order as a reversal of the first global permutation.

As a further explanatory example, the RAM addressing to perform the general permutations is illustrated in the following MATLAB code. Again, for N=m*n, the 1^{st} and 3^{rd} permutations are achieved by the addressing:

a = 0;
do {

a = a + 1;
for row = 0:N−2
Addra=(row*n^{a})mod(N−1);
end
Addra = N−1;

}while(k^{a} mod (N−1)!=1)

For the 2^{nd} permutation, the example MATLAB code is:

a = 0;
do {

a = a + 1;
For row = 0:N−2
Addrb=(row*m^{a})mod(N−1);
End
Addrb = N−1;

}while(m^{a} mod (N−1)!=1)

To further illustrate this particular example addressing for the permutation units 31-33, let us consider a simplified case where N=6, m=3 & n=2. Here, a first set of the 6-point input data is received in natural order as the words: x10, x11, x12, x13, x14, x15. Following the first permutation, the order becomes: [x10, x12, x14], [x11, x13, x15] as n=2 blocks of length m=3. Using a single-port RAM in read-before-write mode, the next N-point set of six words are written into these same RAM addresses 0, 2, 4, 1, 3, 5 and are read out of these addresses according to the required permutation, i.e. in the address sequence 0, 4, 3, 2, 1, 5. In this way, this next set of data x20, x21, x22, x23, x24, x25 is correctly permuted to [x20, x22, x24],[x21, x23, 25]. The third set of input data x30, x31, x32, x33, x34, x35 is now again written into these locations as the old second set of data is read out and the next address sequence applied, i.e. 0, 3, 1, 4, 2, 5, to read out the permuted data [x30, x32, x34],[×31, x33, 35]. A fourth data set x40, x41, x42, x43, x44, x45 now uses these locations and is read out in the address sequence 0, 1, 2, 3, 4, 5 to provide [x40, x42, x44],[x41, x43, 45]. At this point, in this simple example, the above address sequences now repeat indefinitely for the fifth and subsequent sets of input data, allowing the FFT processor to receive further data sets continuously.

FIG. 4 shows the twiddle factor multiplication unit 40 in more detail. Here, the twiddle factor multiplication unit 40 comprises a ROM 44 that stores the twiddle factors and a complex multiplier 42 to multiply the stored twiddle factors supplied from the ROM 44 in turn with the second permuted data 730. In the exemplary embodiment, the ROM 44 stores 2K words of twiddle factor data or more generally N words of predetermined twiddle factor data. In other exemplary embodiments, a twiddle factor generator is used to dynamically generate the twiddle factors. However, the ROM is a more convenient implementation in many circumstances and requires less area than a dynamic generator.

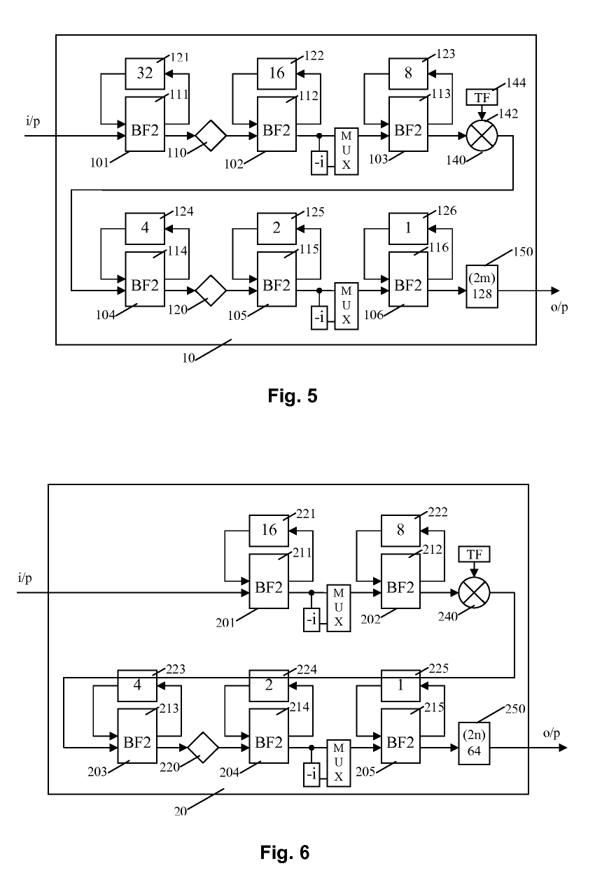

FIG. 5 is a schematic block diagram of the first FFT processor unit 10 in more detail. To minimise the number of multipliers, this example 64-point FFT processor is based on the radix-8 algorithm. As shown in FIG. 5, the first FFT processor unit 10 comprises six pipeline elements (PE) 101-106, a first constant multiplier 110, a second constant multiplier 120, a twiddle factor multiplier unit 140, and a dual-port RAM 150. Each pipeline element 101-106 comprises a radix-2 butterfly 111-116 and a first-in-first-out (FIFO) buffer 121-126. The FIFO buffers 121-126 are used for scheduling the data entering into the respective butterfly unit 111-116, and storing the intermediate results therefrom, so that a single data stream goes through the first FFT processor unit 10. The twiddle factor multiplier unit 140 comprises a complex multiplier 142 and a ROM 144 which stores sixty-four words of local twiddle factor data. The 128-word (2m word) dual-port RAM 150 is used to reorder the data output from the final pipeline element 106 so that the transform results from the first FFT processor 10 are obtained in a natural order for each block of data.

FIG. 6 is a schematic block diagram of the second FFT processor unit 20, comprising first to fifth pipeline elements 201-205, one constant multiplier 220, one twiddle factor multiplier unit 240 and a 64-word (2n word) dual-port RAM 250. Each of the pipeline elements 201-205 comprises a radix-2 butterfly 211-215 and respective FIFO buffers 221-225. The internal architecture of this second FFT unit 20 is similar in construction to the first FFT 10 already described above.

Notably, in the exemplary embodiment discussed above, only 286 words of RAM are used for local data permutation and buffering in the first and second FFT processor units 10, 20.

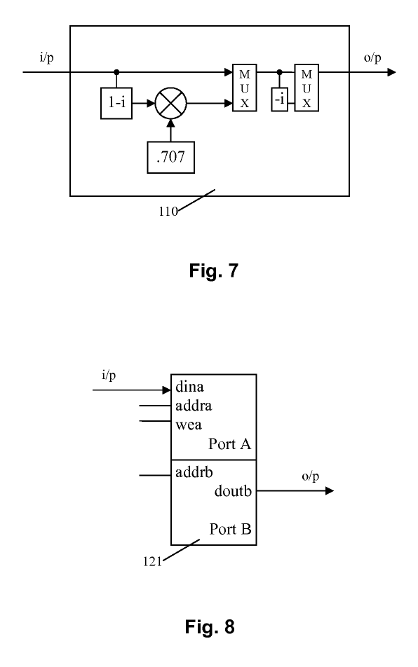

FIG. 7 is a schematic diagram showing the construction of the constant multiplier units 110, 120, 220 used in the first and second FFT processor units 10, 20. In FIG. 7, the first constant multiplier unit 110 is shown for illustration. The constant multipliers 110, 120, 210 are used for multiplications with 1, −i and 0.70711*(±1−i).

To minimize the number of adders and subtracters, canonic signed digit (CSD) and subexpression sharing techniques are used for implementing multiplications with 0.70711. For example, the 9-bit CSD coding of 0.70711 is 1.0-10-10101, so the multiplication with 0.70711 can be implemented with 3 additions and 3 shifts. As shown in FIG. 7, the constant multiplier 110 can be constructed with several adders, subtracters, negators and two multiplexers.

FIG. 8 is a schematic diagram showing an interface of the dual-port RAM used for each of the FIFO buffers 121-126, 221-225. Each of these dual-port RAMS has two independent ports that enable simultaneous access to a single memory space. One port of the dual-port RAM is configured in a write-only mode, whilst the other is configured in a read-only mode. As the dual-port RAM is filled with data, the data are sent to the output port in the same sequence as it enters the RAM.

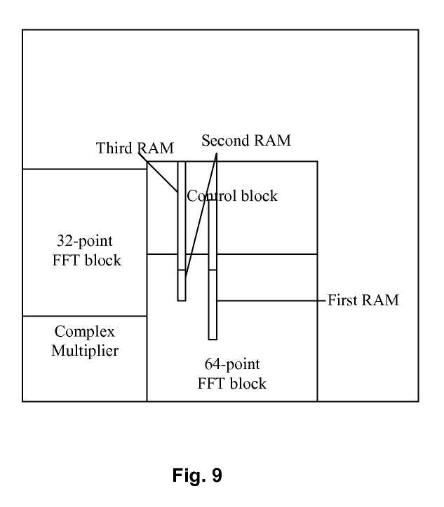

FIG. 9 shows an example floor plan of the above 2K-point FFT processor 100 when implemented using a field programmable gate array (FPGA). Here, it will be appreciated that the complex multiplier unit 40 occupies approximately ⅛^{th} of the total area. By contrast, the single port 2K RAMs of the first, second and third permutation units 31, 24 and 33 occupy a much smaller proportion of the overall area. Thus, the exemplary FFT processor architecture requires only a minimum number of complex multipliers. Further, as shown in FIG. 9, the exemplary architecture employs single-port RAMs 31, 32 & 33 which have a relatively small area and also have relatively low power consumption, compared with other permutation arrangements requiring shift registers or dual-port RAMs which require a much larger area and/or have much larger power consumption.

As noted above, the exemplary 2K-point FFT processor 100 is based on the radix-64/32 algorithm and is constructed using a 64-point FFT processor unit 10, a 32-point FFT processor 20, and three 2K-word permutation RAMs 31, 32, 33. This exemplary FFT processor 100 completes one 2K-point DFT in 2K clock cycles with a delay of 6K clock cycles. Thus, the exemplary architecture has a high throughput. However, there is a slight disadvantage in that there is a relatively long latency.

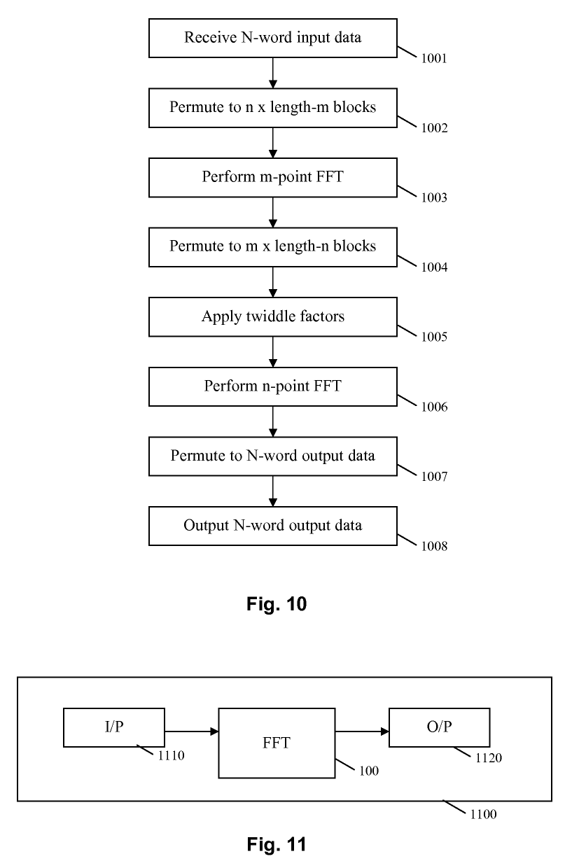

FIG. 10 is a schematic overview of a digital signal processing method according to an exemplary embodiment of the present invention. Here, consistent with the more detailed discussion already provided herein, the method includes a Step 1001 of receiving the N words of input data (700). Step 1002 includes permuting the input data (700) into first permuted data (710) arranged in n data blocks each of length m words. Step 1003 includes performing a fast Fourier transform on the first permuted data (710) using a first m-point FFT processor unit (10) to provide first transformed data (720) arranged in n data blocks each of length m words. Step 1004 includes permuting the first transformed data (720) into second permuted data (730) arranged in m data blocks each of length n words. Step 1005 includes multiplying each of the words of the second permuted data (730) by a predetermined twiddle factor to provide twiddle factor multiplied data (740). Step 1006 includes performing a fast Fourier transform on the twiddle factor multiplied data (740) using a second n-point FFT processor unit (20) to provide second transformed data (750) arranged in m data blocks each of length n words. Step 1007 includes permuting the second transformed data (750) into third permuted data (760). Step 1008 includes outputting the third permuted data (760) as an N-point fast Fourier transform of the input data (700).

FIG. 11 is a schematic overview of a digital signal processing apparatus 1100 according to an exemplary embodiment of the present invention. The apparatus is, for example, an audio DSP and/or a video DSP. The apparatus comprises a receiver unit 1110 arranged to receive input data of length N words, where N=min, m and n are each positive integers, and N is a power of two. Also, the apparatus comprises an FFT processor 100 arranged to perform a fast Fourier transform of the N words of input data to produce N words of output data according to any of the embodiments discussed herein. Further, the apparatus comprises an output unit 1120 arranged to output the N words of output data after processing by the FFT 100.

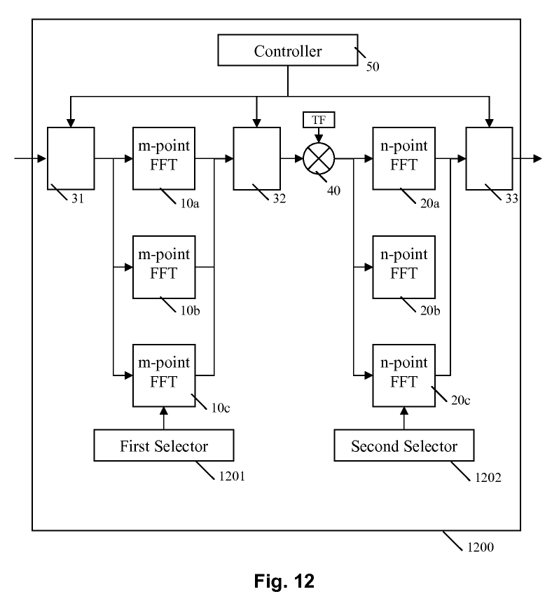

FIG. 12 illustrates an example testing and validation apparatus 1200 according to a further aspect of the present invention. Here, various different designs of m-point and n-point FFT processor units are provided simultaneously. A first selector unit 1201 selects one of the available m-point FFT units 10a-10c. Similarly, a second selector unit 1202 selects one of the available n-point FFT units 20a-20c.

As noted above, in general terms the N-point FFT processor is divided by factors into two smaller m-point and n-point FFT processor units. Here, m and n can be any suitable factors of N such that m times n equals N. Thus, alternate embodiments of the FFT processor architecture may be implemented using a readily available FFT processor unit of any suitable design and construction as available in the related art or elsewhere. Thus, the exemplary architecture is readily adapted to incorporate existing tried and tested smaller FFT processor units to form the required high-point FFT processor. Here, the design and verification of the two small FFT processor units requires much less effort and time than the design and verification of the large FFT processor. Thus, it is easy to implement the exemplary architecture in many different specific forms.

Recent advances in semiconductor processing technology have lead to the evolution of programmable logic chips such as field-programmable gate arrays (FPGAs) and complex programmable logic devices (CPLDs) which increase both in terms of speed and capacity. Hence, the architecture discussed herein is particularly suitable for the rapid prototyping and development of DSP devices incorporating one or more large-point FFT processors.

As will be familiar to those skilled in the art, a limiting factor in most FFT architectures is the complex multiplication required when applying the twiddle factors which therefore leads to a bottleneck. Factoring the high-point FFT into two smaller FFT processor units with a high-radix algorithm substantially reduces the number of complex multipliers and improves the output SNR.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An FFT processor to perform a fast Fourier transform on N words of input data where N=m×n, wherein m and n are both positive integers, the FFT processor comprising:
a first permutation unit arranged to receive the N words of input data and to permute the input data into first permuted data arranged in n data blocks each of length m words;
a first m-point FFT processor unit arranged to perform a fast Fourier transform on the first permuted data to provide first transformed data arranged in n data blocks each of length m words;
a second permutation unit arranged to permute the first transformed data into second permuted data arranged in m data blocks each of length n words;
a twiddle factor multiplication unit comprising a complex multiplier arranged to multiply each word of the second permuted data by a predetermined twiddle factor to provide twiddle factor multiplied data;
a second n-point FFT processor unit arranged to perform a fast Fourier transform on the twiddle factor multiplied data to provide second transformed data arranged in m data blocks each of length n words; and
a third permutation unit arranged to permute the second transformed data into third permuted data and to output the third permuted data as an N-point fast Fourier transform of the input data.

2. The FFT processor of claim 1, further comprising:
a permutation controller arranged to provide address signals to each of the first, second and third permutation units whereby data are written into and read from the first, second and third permutation units according to the address signals.

3. The FFT processor of claim 2, wherein the first, second and third permutation units are each arranged to write data in a sequential order and to read data from the first, second and third permutation units in a permuted sequence according to the address signals supplied by the permutation controller.

4. The FFT processor of claim 1, wherein the first, second and third permutation units each comprise a single-port RAM.

5. The FFT processor of claim 4, wherein the first, second and third permutation units are each arranged to operate in a read-before-write mode.

6. The FFT processor of claim 1, wherein:
the first m-point FFT processor is arranged to process each of the n data blocks of length m words of the first permuted data separately in turn and to write each of the n data blocks of the first transformed data into the second permutation unit; and
the second n-point FFT processor is arranged to process each of the m data blocks of length n words of the twiddle factor multiplied data separately in turn and to write each of the m data blocks of the second transformed data into the third permutation unit.

7. The FFT processor of claim 1, wherein the twiddle factor multiplication unit comprises a ROM arranged to store a plurality of twiddle factors and a complex multiplier arranged to multiply the stored twiddle factors supplied from the ROM in turn with the second permuted data.

8. The FFT processor of claim 1, wherein the first and third permutation units are arranged to perform a permutation as expressed by Equation 1 below and the second permutation unit is arranged to perform a permutation as expressed by Equation 2 below:
for iloop=1, 2, . . . , m, and
jloop=1, 2, . . . , n
ADDR(jloop+(iloop−1)*n)=iloop+(jloop−1)*m (Equation 1)
for iloop=1, 2, . . . , m
and jloop=1, 2, . . . , n
ADDR(iloop+(jloop−1)*m)=jloop+(iloop−1)*n (Equation 2)

9. The FFT processor of claim 1, wherein m=n and the first, second and third permutation units are each arranged to perform the permutation as expressed by Equation 3 below:
For a=0, log 2(N),
ADDR=b*2̂a mod(N−1), when bε[0 N−2],
ADDR=N−1 when b=N−1,
where b=0, 1, 2, 3, . . . , N−1 (Equation 3)

10. The FFT processor of claim 1, wherein m=2n and the second permutation unit is arranged to perform a permutation as expressed by Equation 3 below and the first and third permutation units are each arranged to perform a permutation as expressed by Equation 4 below:
For a=0, log 2(N),
ADDR=b*2̂a mod(N−1), when bε[0 N−2],
ADDR=N−1 when b=N−1,
where b=0, 1, 2, 3, . . . , N−1 (Equation 3)
For a=c*log 2(n)mod log 2(N),
c=0, 1, 2, 3, . . . , log 2(N)−1,
ADDR=b*2̂a mod(N−1), when bε[0 N−2],
ADDR=N−1 when b=N−1,
where b=0, 1, 2 . . . N−1, (Equation 4)

11. A digital signal processing apparatus, comprising:
a receiver unit arranged to receive input data of length N words, where N=m*n, where m and n are each positive integers;
a FFT processor arranged to perform a fast Fourier transform of the N words of input data to produce N words of output data; and
an output unit arranged to output the N words of output data;
wherein the FFT processor is arranged as set forth in claim 1.

12. The digital signal processing apparatus of claim 11, wherein the apparatus comprises a digital audio broadcasting receiver.

13. The digital signal processing apparatus of claim 11, wherein the apparatus comprises a digital video broadcasting receiver.

14. A method of performing a fast Fourier transform on N words of input data where N=m×n, where m and n are both positive integers, the method comprising:
receiving the N words of input data;
permuting the input data into first permuted data arranged in n data blocks each of length m words;
performing a fast Fourier transform on the first permuted data using a first m-point FFT processor unit to provide first transformed data arranged in n data blocks each of length m words;
permuting the first transformed data into second permuted data arranged in m data blocks each of length n words;
multiplying each of the words of the second permuted data by a predetermined twiddle factor to provide twiddle factor multiplied data;
performing a fast Fourier transform on the twiddle factor multiplied data using a second n-point FFT processor unit to provide second transformed data arranged in m data blocks each of length n words;
permuting the second transformed data into third permuted data; and
outputting the third permuted data as an N-point fast Fourier transform of the input data.

15. A testing apparatus for testing an N-point FFT processor arranged to perform a fast Fourier transform on N words of input data where N=m×n, where m and n are both positive integers, the apparatus comprising:
a first permutation unit arranged to receive the N words of input data and to permute the input data into first permuted data arranged in n data blocks each of length m words;
a plurality of m-point FFT processor units each arranged to perform a fast Fourier transform on the first permuted data to provide first transformed data arranged in n data blocks each of length m words;
a second permutation unit arranged to permute first transformed data into second permuted data arranged in m data blocks each of length n words;
a twiddle factor multiplication unit comprising a complex multiplier arranged to multiply each word of the second permuted data by a predetermined twiddle factor to provide twiddle factor multiplied data;
a plurality of n-point FFT processor units each arranged to perform a fast Fourier transform on the twiddle factor multiplied data to provide second transformed data arranged in m data blocks each of length n words;
a third permutation unit arranged to permute the second transformed data into third permuted data and to output the third permuted data as an N-point fast Fourier transform of the input data;
a first selector unit arranged to select one of the plurality of m-point FFT processor units; and
a second selector unit arranged to select one of the plurality of n-point FFT processor units;
whereby the selected one of the plurality of m-point FFT processor units and the selected one of the plurality of n-point FFT processor units are arranged in combination to perform the fast Fourier transform on the N words of input data.
